(19) United States
(12) Patent Application Publication
(10) Pub. No.: US 2019/0331709 A1
(43) Pub. Date: Oct. 31, 2019

(54) SENSOR TESTING SYSTEM AND SENSOR TESTING METHOD APPLIED THERETO

(71) Applicant: Primax Electronics Ltd., Taipei (TW)

(72) Inventors: Pei-Ming Chang, Taipei (TW); Pao-Chung Chao, Taipei (TW); Shih-Chieh Hsu, Taipei (TW)

(21) Appl. No.: 16/044,742

(22) Filed: Jul. 25, 2018

(30) Foreign Application Priority Data
Apr. 27, 2018 (TW) 107114519

(51) Int. Cl. G01P 21/00; G01C 25/00

(52) U.S. Cl. CPC G01P 21/00; G01C 25/00

(57) ABSTRACT

A sensor testing system includes a standard unit and a test fixture. The standard unit and plural under-test sensors are placed on a test platform of the test fixture. A sensor testing method includes following steps. Firstly, the standard unit and the plural under-test sensors are arranged to generate a main process. Then, the standard unit and the plural under-test sensors are assigned to generate plural sub-threads according to the main process. When the main process is executed, the plural sub-threads are synchronously executed. Then, the test platform is enabled to create a motion in a first direction, and the main process waits for a predetermined time period. Then, the standard unit and the under-test sensors sense the motion in the first direction. When the sensing results are generated, the standard unit and the under-test sensors respond to the main process.

### FIELD OF THE INVENTION

The present invention relates to a sensor testing system and a sensor testing method, and more particularly to a sensor testing system and a sensor testing method for executing a main process and synchronously executing plural sub-threads so as to simultaneously test plural under-test sensors and reduce the testing time period.

### BACKGROUND OF THE INVENTION

As a micro-electro-mechanical system (MEMS) technology is gradually developed, many types of motion sensors have been widely used in consumer electronic products such as smart phones, tablet computers, game consoles or remote controllers. According to the sensing results of piezoelectric effects, these motion sensors calculate the changes of accelerations or rotating angles of the electronic products in the space. By the MEMS technology, the electronic products can be intuitively operated to control associated functions.

Nowadays, the widely-used motion sensors include G-sensors, gyroscopes, accelerometer sensors, or the like. The accelerometer sensor is used for sensing the directions of the acceleration in three dimensions. The gyroscope is used for sensing the angular velocities along one axis or plural axes. Generally, the device with the function of sensing motions is equipped with one motion sensor or the combination of plural motion sensors. For example, the accelerometer sensor and the gyroscope in the combination are complementary with each other to calculate the complete motion in the three-dimensional space.

Moreover, an inertial measurement unit (IMU) is a more precise sensor. The inertial measurement unit is a combination of plural motion sensors in multiple axes. For example, the inertial measurement unit is combination of a three-axis gyroscope and a three-direction accelerometer sensor. Since the cost of the inertial measurement unit is high, the inertial measurement unit is usually installed in a high performance instrument or a high specification instrument. The general consumer electronic product usually uses the low cost sensor (e.g., the accelerometer sensor or the gyroscope) as the motion sensor.

Moreover, the inertial measurement unit can be used in the sensor testing system for testing the functions of the motion sensors (e.g., gyroscopes or accelerometer sensors) in the production line. In accordance with the conventional testing method, one motion sensor (e.g., the gyroscope or the accelerometer sensor) and one inertial measurement unit are placed on the same test platform in a test fixture. Moreover, the test fixture creates a three-dimensional motion (e.g., the motion including a translation and a rotation) on the test platform. The inertial measurement unit is a test standard for the under-test motion sensors.

While the test fixture is moved, the supervisory computer receives the sensing results from the motion sensor and the inertial measurement unit. Since the motion sensor and the inertial measurement unit are disposed on the same plane, the data transmitted from the motion sensor and the inertial measurement unit to the computer are identical or slightly different. The testing procedure further compares the sensing result of the motion sensor with the sensing result of the inertial measurement unit in order to judge the performance of the sensor. Then, a program is executed to correct the sensing error of the sensor through a special algorithm.

Although the conventional testing method is capable of effectively and accurately testing the sensor, there are still some drawbacks. For example, one under-test object is tested at each time. That is, after the motions of the sensor in all axis directions are tested, the next sensor is tested. In order to test a great number of sensors, the conventional testing method is time-consuming. In case that the area of the test fixture is increased to accommodate plural under-test objects, the conventional testing method is only able to successively test and control the under-test objects. That is, the number of times of moving the test platform is equal to the number of the sensors. Since only the time period of replacing the sensors and placing the sensors on the test platform is saved, the time period of performing the testing method is still long.

### SUMMARY OF THE INVENTION

The present invention provides a sensor testing system and a sensor testing method. In the sensor testing system, a standard unit and plural under-test sensors are placed on the same test platform. In the sensor testing method, plural sub-threads are synchronously executed with the main process. Since plural under-test sensors are simultaneously tested, the time period of testing a great number of sensors is largely reduced.

In accordance with an aspect of the present invention, there is provided a sensor testing method for a sensor testing system and plural under-test sensors. The sensor testing system includes a first computing device, a standard unit and a test fixture. The standard unit and the plural under-test sensors are placed on a test platform of the test fixture. The first computing device is in communication with the test fixture. The sensor testing method includes the following steps. Firstly, the standard unit and the plural under-test sensors are arranged to generate a main process. Then, the standard unit and the plural under-test sensors are assigned to generate plural sub-threads according to the main process. Then, the main process is executed, and the plural sub-threads are synchronously executed. Then, the test platform of the test fixture is enabled to create a motion in a first direction of plural predetermined directions, and the main process waits for a predetermined time period. Then, the standard unit and the under-test sensors sense the motion in the first direction to acquire sensing results. When the sensing results are generated, the standard unit and the under-test sensors respond to the main process, so that the sensing results are transmitted to the first computing device through the test fixture.

In accordance with another aspect of the present invention, there is provided a sensor testing system for testing plural under-test sensors. The sensor testing system includes a test fixture, a standard unit and a first computing device. The test fixture includes a test platform. The test fixture is movable in plural predetermined directions. The standard unit and the plural under-test sensors are placed on the test platform. The first computing device is in communication with the test fixture to control the test fixture. The first computing device arranges the standard unit and the plural under-test sensors to generate a main process and assigns the standard unit and the plural under-test sensors to generate plural sub-threads according to the main process. When the main process is executed, the plural sub-threads are synchronously executed. When the test platform of the test fixture creates a motion in a first direction of the plural predetermined directions, the main process waits for a predetermined time period, and the standard unit and the under-test sensors sense the motion in the first direction to acquire sensing results. When the sensing results are generated, the standard unit and the under-test sensors respond to the main process, so that the sensing results are transmitted to the first computing device through the test fixture.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 schematically illustrates the architecture of a sensor testing system according to an embodiment of the present invention;

FIG. 2 is a flowchart illustrating a sensor testing method according to an embodiment of the present invention; and

FIG. 3 schematically illustrates the main process M1 and the sub-threads T0, T1, T2 and T3 that are generated in response to the execution of the test application program.

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

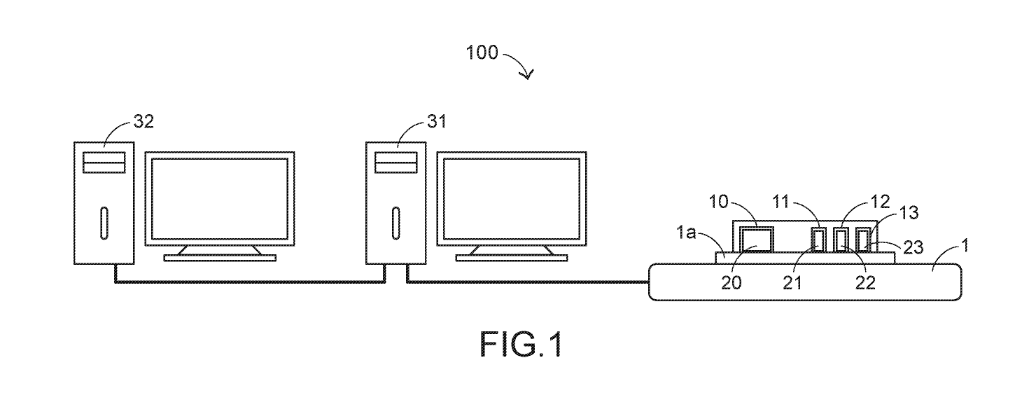

The present invention provides a sensor testing system and a sensor testing method for the sensor testing system. FIG. 1 schematically illustrates the architecture of a sensor testing system according to an embodiment of the present invention. As shown in FIG. 1, the sensor testing system 100 comprises a first computing device 31, a second computing device 32 and a test fixture 1. The test fixture 1 is movable along plural predetermined directions. The first computing device 31 is in communication with the test fixture 1. The second computing device 32 is in communication with the first computing device 31.

In the sensor testing system 100, the test fixture 1 is used for testing the functions of motion sensors (e.g., gyroscopes or accelerometer sensors) in the production line. The sensor testing system 100 further comprises a standard unit 20. The standard unit 20 is used as a test standard for various under-test motion sensors. In an embodiment, the standard unit 20 is an inertial measurement unit (IMU) for providing a standard specification about the precise sensing result and the comparison of the three-dimensional motion (e.g., the motion including a translation and a rotation).

In accordance with an object of the present invention, the sensor testing system 100 is capable of testing the functions of plural under-test motion sensors in the same testing process at one time. That is, as shown in FIG. 1, the sensor testing system 100 is capable of testing the under-test sensors 21, 22 and 23 simultaneously. The test fixture 1 further comprises a test platform 1a. The test platform 1a can perform the three-dimensional motion relative to the test fixture 1. For comparing the sensing results of different motion sensors with each other, the standard unit 20 and the under-test sensors 21, 22 and 23 are placed on the test platform 1a together.

For simultaneously testing the plural under-test motion sensors, the test platform 1a comprises plural installation seats 10, 11, 12 and 13. The standard unit 20 and the under-test sensors 21, 22 and 23 are placed on the installation seats 10, 11, 12 and 13, respectively. The number of the installation seats is not restricted. However, the total number of the standard unit and the under-test sensors is not larger than the number of the installation seats. For succinctness, only three under-test sensors 21, 22 and 23 are shown in FIG. 1. As the number of the installation seats is increased, more under-test sensors can be placed on the installation seats and thus the testing time period will be saved.

As mentioned above, the standard unit 20 is used as the test standard for the under-test sensors 21, 22 and 23. However, in accordance with a feature of the present invention, the standard unit 20 and the under-test sensors 21, 22 and 23 are placed in the same environment to sense their own motion statuses to acquire the corresponding sensing results. More especially, during the process of testing the same group of the under-test sensors, the number of the sensing results of the standard unit 20 is equal to the number of the sensing results of the plural under-test sensors.

In an embodiment, the first computing device 31 as shown in FIG. 1 is a supervisory controller for controlling and monitoring the testing process. The second computing device 32 is responsible for receiving, managing, comparing, analyzing and correcting the sensing results. In an embodiment, the first computing device 31 is an industrial computer that uses a PCI interface and is in communication with the test fixture 1. The second computing device 32 for collecting data is not an industrial computer. The second computing device 32 has a USB interface. The architecture of the sensor testing system 100 using the two computing devices is not restricted. For example, in case that a single computing device has the functions of performing industrial control and collecting, comparing and analyzing data, the sensor testing system with the single computing device is feasible.

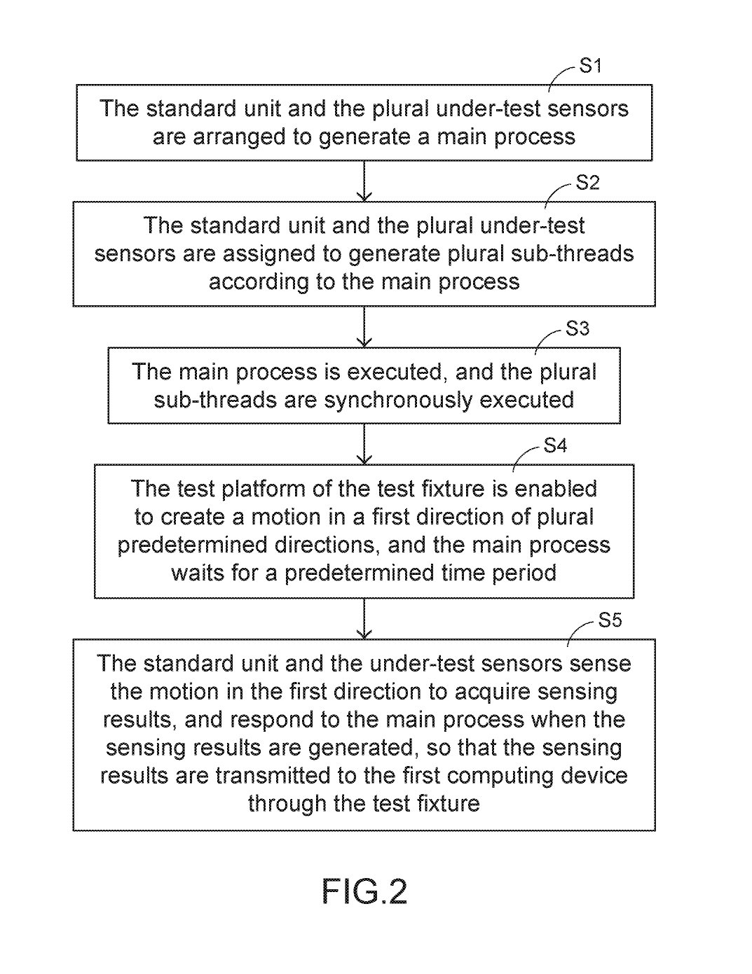

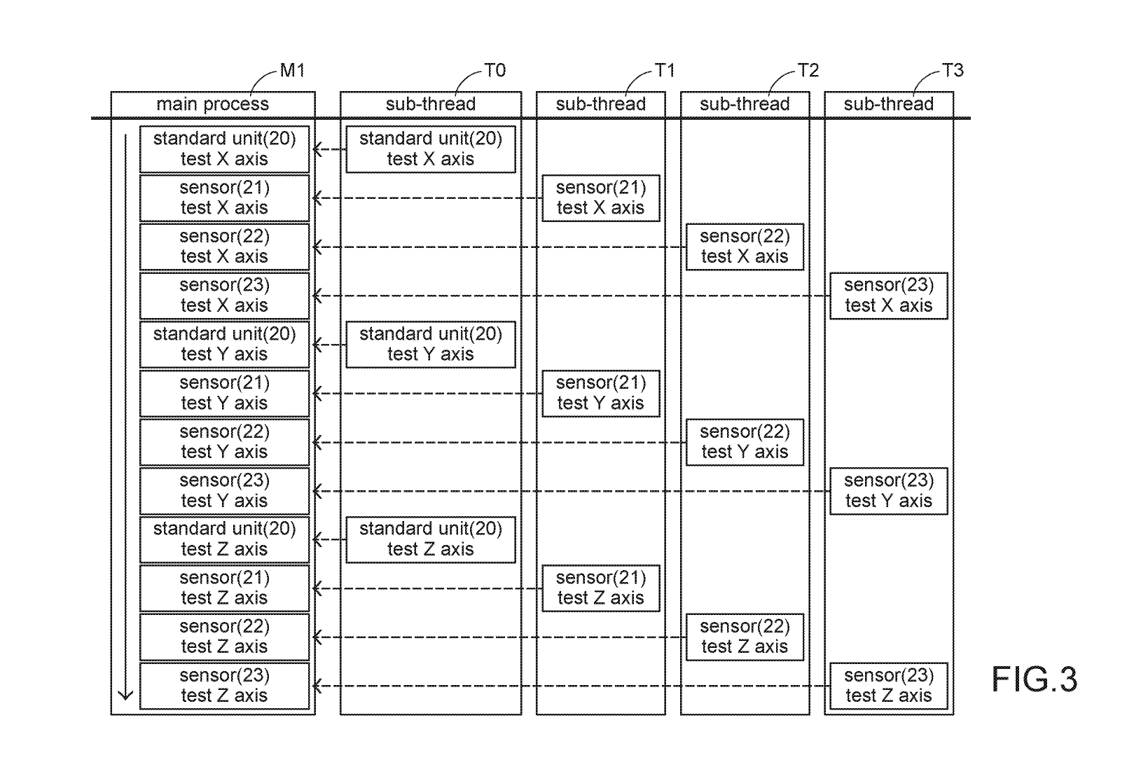

FIG. 2 is a flowchart illustrating a sensor testing method according to an embodiment of the present invention. Firstly, in a step S1, the standard unit 20 and the under-test sensors 21, 22 and 23 are arranged to generate a main process M1 (see FIG. 3). In a step S2, the standard unit 20 and the under-test sensors 21, 22 and 23 are assigned to generate plural sub-threads T0, T1, T2 and T3 (see FIG. 3) according to the main process M1. In a step S3, the main process M1 is executed, and the plural sub-threads T0, T1, T2 and T3 are synchronously executed. In a step S4, the test platform 1a of the test fixture 1 is enabled to create a motion in a first direction of plural predetermined directions, and the main process M1 waits for a predetermined time period. In a step S5, the standard unit 20 and the under-test sensors 21, 22 and 23 sense the motion in the first direction to acquire sensing results, and respond to the main process M1 when the sensing results are generated. Consequently, the sensing results are transmitted to the first computing device 31 through the test fixture 1.

The sensor testing method is applied to the sensor testing system 100. In an embodiment, the sensor testing method is saved as a software (e.g., a test application program) in the test fixture 1. When the test application program is executed, the sensor testing method is performed. As mentioned above, the first computing device 31 is used as the supervisory controller. When the first computing device 31 is in communication with the test fixture 1, the test application program loaded in the test fixture 1 is executed by the first computing device 31 through the test fixture 1. Consequently, the testing process is correspondingly controlled. The installation seats 10, 11, 12 and 13 can be used to stably fix the standard unit 20 and the under-test sensors 21, 22 and 23, respectively. In addition, the installation seats 10, 11, 12 and 13 are also used as signal transmission interfaces. Consequently, the sensing results generated by the standard unit 20 and the under-test sensors 21, 22 and 23 are outputted from the installation seats 10, 11, 12 and 13, respectively.

Moreover, the standard unit 20 is fixedly installed on the test fixture 1. That is, the standard unit 20 does not need to be replaced, and the standard unit 20 is single. After the procedures of testing the under-test sensors 21, 22 and 23 are completed, the under-test sensors 21, 22 and 23 are replaced with the under-test sensors of a next batch. When the testing process is started or the test application program is executed, the step S1 further comprises a step of detecting the number of the under-test sensors 21, 22 and 23 in the test fixture 1. Consequently, the sub-threads T0, T1, T2 and T3 are generated in the subsequent step.

FIG. 3 schematically illustrates the main process M1 and the sub-threads T0, T1, T2 and T3 that are generated in response to the execution of the test application program. As shown in FIG. 3, the sub-threads T0, T1, T2 and T3 corresponding to the standard unit 20 and the under-test sensors 21, 22 and 23 are used for sensing motions. For succinctness, only four sub-threads are shown. In the main process M1 and the sub-threads T0, T1, T2 and T3, the sequence in the later order and the progress of the timing sequence are shown in the lower sites of FIG. 3. In an embodiment, the plural predetermined directions in FIG. 3 are indicated with a three-dimensional coordinate system. That is, the plural predetermined directions include an X-axis direction, a Y-axis direction and a Z-axis direction, which are perpendicular to each other.

In an embodiment, the main process M1 is a test instruction set for sequentially moving the standard unit 20 and the under-test sensors 21, 22 and 23 in the plural predetermined directions. Particularly, after the test application program is executed, a corresponding testing arrangement is started. The testing arrangement is determined according to the sequences of the standard unit 20 and the under-test sensors 21, 22 and 23 (or the positions of the corresponding installation seats). Moreover, the testing arrangement is related to the combination of the sequences of the X-axis direction, the Y-axis direction and the Z-axis direction. In the example of FIG. 3, the main process M1 contains 12 test instructions.

In accordance with the present invention, the test instructions are specially arranged. Consequently, after the four under-test objects are moved in a specified predetermined direction and sensed, the four under-test objects are moved in a next predetermined direction and sensed. For example, the motion in the first direction (e.g., the X-axis direction) is firstly sensed, then the motion in the second direction (e.g., the Y-axis direction) is sensed, and finally the motion in the third direction (e.g., the Z-axis direction) is sensed. Consequently, it is not necessary to create so many motions on the test platform 1a. Since all of the under-test objects are placed on the same test platform 1a, the sensing results of the under-test objects are obtained in response to the motion on the test platform 1a in the same direction at each time.

Moreover, the standard unit 20 and the under-test sensors 21, 22 and 23 are assigned to generate the corresponding sub-threads according to the test instructions corresponding to the motions in the plural predetermined directions. Particularly, in the step S2, the under-test objects (i.e., the standard unit 20 and the under-test sensors 21, 22 and 23) associated with the test instructions are assigned to generate the sub-threads T0, T1, T2 and T3 after the test application program is executed and the main process M1 is generated. In other words, the main process M1 is the set of the sub-threads T0, T1, T2 and T3.

In accordance with another feature of the present invention, the plural sub-threads and the main process of synchronously performed to test the plural under-test sensors. The procedure of executing the test application program to generate the main process is similar to the conventional technology of testing an under-test object at each time. That is, an instruction is executed at each time. After the main process M1 is started, all of the instructions are sequentially executed to complete the whole main process M1. However, in the step S3, the time duration of executing the main process M1 is distributed to the other processes because the sub-threads T0, T1, T2 and T3 are synchronously executed. In such way, the multi-task mechanism can be simulated.

Although each of the sub-threads T0, T1, T2 and T3 is executed according to one instruction at each time, plural processes are simultaneously performed according to the corresponding instructions. Consequently, the standard unit 20 and the under-test sensors 21, 22 and 23 can simultaneously sense the motion statuses to acquire the corresponding sensing results. In other words, even if the so many under-test sensors are placed on the test platform 1a, the time period of synchronously executing the plural sub-threads is nearly equal to the time period of executing a single sub-thread. The total time period of the testing process is nearly equal to the time period of testing one under-test sensor. Consequently, the sensor testing method of the present invention has the time-saving benefit.

In the step S4, the sub-threads T0, T1, T2 and T3 are synchronously executed. The standard unit 20 and the under-test sensors 21, 22 and 23 senses the motion of the test platform 1a in the first direction (i.e., the X-axis direction), and thus the corresponding sensing results are obtained. As mentioned above, the testing process needs to create the motions in the plural directions and generate the corresponding sensing results. For accurately completing the procedures of testing all under-test sensors, a waiting mechanism has to be added to the main process M1.

Generally, different sensors have different quality conditions or operating conditions. In addition, if the sensor has a breakdown, the sensor cannot generate the sensing result and return back the sensing result. In accordance with the present invention, the main process M1 waits for the predetermined time period. Consequently, if the sensing procedure is not completed within the predetermined time period, the subsequent instruction of the next axis direction will not be executed. Moreover, if the sensing result is not received after the predetermined time period, the corresponding instruction will not be continuously executed. In case that the under-test sensor is not abnormal, the time period of returning the sensing result is very short, for example a fraction of a second or several milliseconds. Therefore, the predetermined time period can be designed as one second or several seconds.

In a step S5, the standard unit 20 and the under-test sensors 21, 22 and 23 sense the motion in the first direction (e.g., the X-axis direction) while the sub-threads T0, T1, T2 and T3 are synchronously executed. Please refer to the horizontal dotted lines of FIG. 3. Whenever the sensing results are generated, the standard unit 20 and the under-test sensors 21, 22 and 23 respond to the main process M1 immediately. As mentioned above, all commands for the main process M1 are sequentially executed. However, in the sub-threads T0, T1, T2 and T3, the procedures of responding the sensing results of the motion corresponding to one axis direction (e.g., the X-axis direction, the Y-axis direction or the Z-axis direction) are simultaneously performed or almost simultaneously performed.

As mentioned above in FIG. 1, the first computing device 31 is responsible for controlling the test fixture 1, and the second computing device 32 is responsible for collecting, processing and analyzing data. Consequently, after the standard unit 20 and the under-test sensors 21, 22 and 23 respond to the main process M1 and the generated sensing results are transmitted to the first computing device 31 through the test fixture 1, the sensing results are transmitted from the first computing device 31 to the second computing device 32.

In an embodiment, an application program is loaded in the second computing device 32 to process the collected sensing results or the collected data. Particularly, when the application program is executed, the sensing result of the standard unit 20 is compared with the sensing results of the under-test sensors 21, 22 and 23, and the sensing errors are introduced into the special algorithm to generate correction information. Then, the corresponding sensors are corrected according to the correction information. In an embodiment, an associated device may be used to re-edit the firmware contents of the corresponding sensors to perform the correcting process. The way of performing the correcting process is well known to those skilled in the art, and is not redundantly described herein.

As above mentioned, the steps S1˜S5 are effective to test the plural under-test sensors because the plural sub-threads are synchronously performed. Moreover, due to the waiting mechanism, the sensing result that should be obtained is received. In case that the main process M1 and the sub-threads T0, T1, T2 and T3 are synchronously executed and the steps S4 and S5 corresponding to the other predetermined directions such as the second axis direction (Y-axis direction) and the third axis direction (Z-axis direction) are performed, the overall testing process and the required sensing results are generated. Moreover, the predetermined time period corresponding to other directions is identical to the predetermined time period of the above testing process. Alternatively, the predetermined time period for the waiting mechanism may be varied according to the practical requirements.

The above waiting mechanism also has the following features. If the corresponding sensing result has not been received after the predetermined time period, the main process M1 is continuously performed. At the same time, the sub-threads T0, T1, T2 and T3 continuously respond to the main process M1 about the sensing results. Moreover, if the testing procedures in all predetermined directions (e.g., in the X-axis direction, the Y-axis direction and the Z-axis direction) are completed and the corresponding sensing results respond to the main process M1 within the predetermined time period, the second computing device 32 starts to process and analyze the collected data.

Moreover, if the sensing result of any under-test sensor is not received by the first computing device 31 after the predetermined time period, or if the second computing device 32 analyzes the sensing results and realizes that the sensing result corresponding to any under-test sensor is beyond a predetermined range, the program judges that the corresponding under-test sensor is abnormal. Whereas, if the above condition is not satisfied, the program judges that the corresponding under-test sensor is normal. The predetermined range is an acceptable level about the sensing error of the under-test sensor relative to the sensing result of the standard unit 20.

From the above descriptions, the present invention provides a sensor testing system. In the sensor testing system, a test fixture for placing plural under-test sensors is provided and a standard unit as a test standard and the plural under-test sensors are subjected to the motion test on the same test platform. The present invention also provides a sensor testing method for the sensor testing system. The sensor testing method provides plural sub-threads, and the sub-threads are synchronously executed with the main process. Consequently, the plural under-test sensors are effectively subjected to the motion test at one time. Regardless of the number of the under-test objects, the total time period of the testing process is nearly equal to the time period of testing one under-test sensor. Consequently, the sensor testing method of the present invention has the time-saving benefit.

In other words, the sensor testing system and the sensor testing method can effectively overcome the drawbacks of the conventional technologies.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims which are to be accorded with the broadest interpretation so as to encompass all modifications and similar structures.

What is claimed is:

1. A sensor testing method for a sensor testing system and plural under-test sensors, the sensor testing system comprising a first computing device, a standard unit and a test fixture, the standard unit and the plural under-test sensors being placed on a test platform of the test fixture, the first computing device being in communication with the test fixture, the sensor testing method comprising steps of:
arranging the standard unit and the plural under-test sensors to generate a main process;
assigning the standard unit and the plural under-test sensors to generate plural sub-threads according to the main process;
executing the main process, and synchronously executing the plural sub-threads;
enabling the test platform of the test fixture to create a motion in a first direction of plural predetermined directions, and allowing the main process to wait for a predetermined time period; and
allowing the standard unit and the under-test sensors to sense the motion in the first direction to acquire sensing results, wherein when the sensing results are generated, the standard unit and the under-test sensors respond to the main process, so that the sensing results are transmitted to the first computing device through the test fixture.

2. The sensor testing method according to claim 1, wherein the sensor testing method is performed when a test application program in the test fixture is executed, and the sensor testing method further comprises steps of:
executing the test application program by the first computing device through the test fixture; and
detecting a number of the plural under-test sensors by the test fixture.

3. The sensor testing method according to claim 1, further comprising steps of:
enabling the test platform of the test fixture to create a motion in a second direction of plural predetermined directions, and allowing the main process to wait for the predetermined time period; and
allowing the standard unit and the under-test sensors to sense the motion in the second direction to acquire sensing results, wherein when the sensing results are generated, the standard unit and the under-test sensors respond to the main process, so that the sensing results are transmitted to the first computing device through the test fixture.

4. The sensor testing method according to claim 1, wherein the sensor testing system further comprises a second computing device, and the second computing device is in communication with the first computing device, wherein the sensor testing method further comprises steps of:
allowing the sensing results of the standard unit and the under-test sensors to be transmitted from the first computing device to the second computing device;
generating a correction information by the second computing device according to a result of comparing the sensing result of the standard unit with the sensing results of the under-test sensors; and
correcting the under-test sensors according to the correction information.

5. The sensor testing method according to claim 1, wherein if the sensing result of any under-test sensor is not received by the first computing device after the predetermined time period, or if the sensing result corresponding to any under-test sensor is beyond a predetermined range, the under-test sensor is determined as an abnormal sensor.

6. The sensor testing method according to claim 1, wherein the main process is a test instruction set for sequentially moving the standard unit and the plural under-test sensors in the plural predetermined directions.

7. The sensor testing method according to claim 1, wherein the standard unit and the under-test sensors are assigned to generate the corresponding sub-threads according to test instructions corresponding to the motions in the plural predetermined directions.

8. A sensor testing system for testing plural under-test sensors, the sensor testing system comprising:
a test fixture comprising a test platform, wherein the test fixture is movable in plural predetermined directions;
a standard unit, wherein the standard unit and the plural under-test sensors are placed on the test platform; and
a first computing device in communication with the test fixture to control the test fixture, wherein the first computing device arranges the standard unit and the plural under-test sensors to generate a main process and assigns the standard unit and the plural under-test sensors to generate plural sub-threads according to the main process,
wherein when the main process is executed, the plural sub-threads are synchronously executed, wherein when the test platform of the test fixture creates a motion in a first direction of the plural predetermined directions, the main process waits for a predetermined time period, and the standard unit and the under-test sensors sense the motion in the first direction to acquire sensing results, wherein when the sensing results are generated, the standard unit and the under-test sensors respond to the main process, so that the sensing results are transmitted to the first computing device through the test fixture.

9. The sensor testing system according to claim 8, wherein the test platform comprises plural installation seats, and the standard unit and the under-test sensors are placed on the corresponding installation seats, wherein a total number of the standard unit and the plural under-test sensors is not larger than a number of the plural installation seats, and the test fixture detects the number of the plural under-test sensors through the plural installation seats.

10. The sensor testing system according to claim 8, wherein when the test platform of the test fixture creates a motion in a second direction of the plural predetermined directions, the main process waits for the predetermined time period, and the standard unit and the under-test sensors sense the motion in the second direction to acquire sensing results, wherein when the sensing results are generated, the standard unit and the under-test sensors respond to the main process, so that the sensing results are transmitted to the first computing device through the test fixture.

11. The sensor testing system according to claim 8, wherein the sensor testing system further comprises a second computing device, and the second computing device is in communication with the first computing device, wherein the sensing results of the standard unit and the under-test sensors are transmitted from the first computing device to the second computing device, a correction information is generated by the second computing device according to a result of comparing the sensing result of the standard unit with the sensing results of the under-test sensors, and the under-test sensors is corrected according to the correction information.

12. The sensor testing system according to claim 8, wherein if the sensing result of any under-test sensor is not received by the first computing device after the predetermined time period, or if the sensing result corresponding to any under-test sensor is beyond a predetermined range, the under-test sensor is determined as an abnormal sensor.
